(19) United States
(12) Patent Application Publication
(10) Pub. No.: US 2012/0270041 A1
(43) Pub. Date: Oct. 25, 2012

(54) PRESSURE-SENSITIVE ADHESIVE FUNCTIONAL FILM AND DISPLAY DEVICE

(75) Inventors: Mitsuo MATSUMOTO, Osaka (JP); Tomohide BANBA, Osaka (JP); Tatsuya SUZUKI, Osaka (JP)

(73) Assignee: NITTO DENKO CORPORATION, Osaka (JP)

(21) Appl. No.: 13/452,272

(22) Filed: Apr. 20, 2012

(30) Foreign Application Priority Data
Apr. 22, 2011 (JP) 2011-096497

(51) Int. Cl. C09J 7/02; B32B 7/12

(52) U.S. Cl. 428/354

(57) ABSTRACT

The present invention provides a transparent pressure-sensitive adhesive functional film in which interference fringes hardly occur and corrosion resistance is excellent. The invention relates to a pressure-sensitive adhesive functional film including a transparent substrate, a functional layer (hard coat layer and/or anti-reflection layer) on one surface of the transparent substrate, and a pressure-sensitive adhesive layer on the other surface of the transparent substrate, wherein an amount of (meth)acrylic acid ion extracted from the pressure-sensitive adhesive functional film under the specific conditions is suitably controlled, and an approximate integral value calculated by using a transmittance curve at a wavelength of 400 to 780 nm is suitably controlled.

### BACKGROUND OF THE INVENTION

1. Technical Field

The present invention relates to a pressure-sensitive adhesive functional film and a display device. More particularly, the present invention relates to a pressure-sensitive adhesive functional film used in an optical application such as a manufacture of an optical product or an optical member. Further, the present invention relates to a display device which includes the pressure-sensitive adhesive functional film.

2. Background Art

Recently, a display device such as a liquid crystal display (LCD) or an input device such as a touch panel which is used by combining with the display device, has been widely used in various fields. In the display device or the input device, a variety of transparent functional films have been used. Examples of this functional film include a hard coat film used for improving anti-scratch property, an anti-reflection film used for improving anti-reflectivity, and the like.

In general, while the functional film can be fixed to an adherent by using an adhesive, there is a problem that this fixation operation is cumbersome in the manufacture process of a product. To solve this problem, a pressure-sensitive adhesive functional film having a pressure-sensitive adhesive layer on at least one surface of the functional film has been widely used from the viewpoint of easy fixation to the adherent and reduction of production costs (see, for example, Patent Documents 1 and 2).
Patent Document 1: JP 2001-234135 A
Patent Document 2: JP 2002-47463 A

### SUMMARY OF THE INVENTION

However, recent improvements in display quality of a display device caused some problems that the interference fringes (rainbow fringes) occur in optical products (for example, a device made by combining a liquid crystal display with a touch panel, and the like), depending on the pressure-sensitive adhesive functional films, and thus, the visibility or display quality of the display part (display) of optical products was degraded, or the appearance of optical products was adversely affected.

In addition, if the material of part of an adherent to which the pressure-sensitive adhesive functional film is laminated is metal or metal oxide (for example, a transparent conductive membrane of a transparent conductive film such as ITO film, and the like), the pressure-sensitive adhesive functional film has been required to have a characteristic that does not corrode the adherent. Because of this, the pressure-sensitive adhesive functional film, in which the interference fringes hardly occur and corrosion resistance is excellent, has been required in the present situation.

Therefore, the present invention has been made in an effort to provide a transparent pressure-sensitive adhesive functional film including a functional layer for exerting a function of anti-scratch and/or anti-reflectivity and a pressure-sensitive adhesive layer for fixing by laminating to the adherent, in which corrosion resistance is excellent, and further, the interference fringes hardly occur. In addition, in the present specification, “corrosion resistance” means a characteristic that does not corrode the adherent.

Accordingly, the present inventors have studied in order to solve the problems. As a result, the inventors have found out that a pressure-sensitive adhesive functional film including at least one functional layer selected from the group consisting of a hard coat layer and an anti-reflection layer on one surface side of a transparent substrate, and a pressure-sensitive adhesive layer on the other surface of the transparent substrate, in which corrosion resistance is excellent, and further the interference fringes hardly occur, can be obtained by controlling the total amount of an acrylic acid ion and a methacrylic acid ion extracted from the pressure-sensitive adhesive functional film by boiling and the approximate integral value calculated using the certain parts of the transmittance curve within a specific range. The present invention has been completed based on these findings.

That is, the present invention provides a pressure-sensitive adhesive functional film, including:

a transparent substrate;

at least one functional layer selected from the group consisting of a hard coat layer and an anti-reflection layer on one surface of the transparent substrate; and

a pressure-sensitive adhesive layer on the other surface of the transparent substrate,

wherein a total amount of an acrylic acid ion and a methacrylic acid ion, which are extracted from the pressure-sensitive adhesive functional film with pure water under the condition of 100° C. and 45 min, is 20 ng/cm² or less per unit area of the pressure-sensitive adhesive layer, as measured by an ion chromatograph method, and

an approximate integral value calculated by using a transmittance curve at a wavelength of 400 to 780 nm is 50 or less, as measured by a spectral transmittance meter.

In addition, in the pressure-sensitive adhesive functional film, the pressure-sensitive adhesive layer preferably includes an acrylic polymer formed from a component including, as essential monomer components, alkyl ester(meth)acrylate and/or alkoxy alkyl ester(meth)acrylate, and a polar group-containing monomer.

In addition, in the pressure-sensitive adhesive functional film, the polar group-containing monomer preferably includes a hydroxyl group-containing monomer.

In addition, the pressure-sensitive adhesive functional film preferably includes:

a functional film including the transparent substrate, and the hard coat layer on one surface of the transparent substrate; and

the pressure-sensitive adhesive layer on the other surface of the transparent substrate which is on the side opposite to the hard coat layer,

wherein the functional film has a total light transmittance of 87% or more and a haze of 1.5% or less, and a pencil hardness on the surface of the hard coat layer is HB or harder.

In addition, the present invention provides a display device including the pressure-sensitive adhesive functional film.

Since the pressure-sensitive adhesive functional film of the present invention has the above configuration, interference fringes hardly occur, the visibility or display quality of the display image of the display part of products is not degraded, and the appearance of products is not adversely affected. In addition, the pressure-sensitive adhesive functional film of the present invention has an excellent corrosion resistance, so that the film does not degrade the performance such as a conductive property of products. Accordingly, the pressure-sensitive adhesive functional film of the present invention can preferably be used in an optical application such as the manufacture of optical products or optical members.

### BRIEF DESCRIPTION OF THE DRAWINGS

FIG. 1 is a schematic view (cross-sectional view) illustrating the pressure-sensitive adhesive functional film of the present invention.

FIG. 2 is a view illustrating a transmittance curve measured on the pressure-sensitive adhesive functional film obtained in Example 1 within the wavelength range of 400 nm to 780 nm.

FIG. 3 is a schematic view (plan view) illustrating a sample for evaluation used in evaluating corrosion resistance in Examples.

### DETAILED DESCRIPTION OF THE INVENTION

The pressure-sensitive adhesive functional film of the present invention includes: a transparent substrate; at least one functional layer selected from the group consisting of a hard coat layer and an anti-reflection layer on one surface of the transparent substrate; and a pressure-sensitive adhesive layer on the other surface of the transparent substrate.

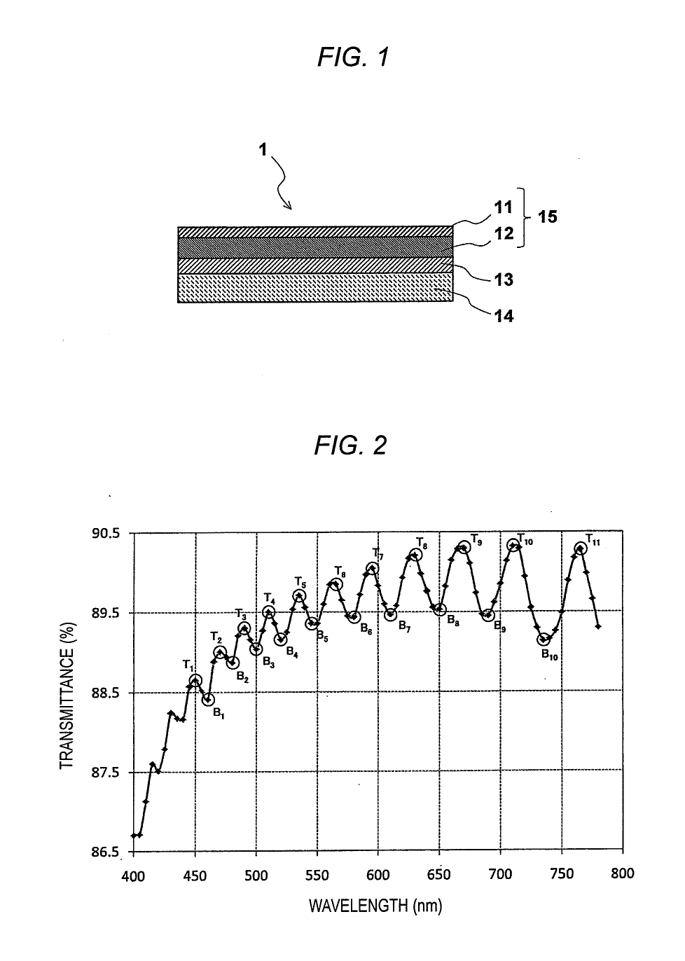

FIG. 1 is a schematic view (cross-sectional view) showing the pressure-sensitive adhesive functional film of the present invention. In FIG. 1, reference numeral 1 is the pressure-sensitive adhesive functional film of the present invention, reference numeral 11 is a functional layer, reference numeral 12 is a transparent substrate, reference numeral 13 is a pressure-sensitive adhesive layer, and reference numeral 14 is a release liner (separator). In addition, in the present specification, a laminate composed of a transparent substrate and a functional layer on one surface of the transparent substrate (i.e., corresponding to the configuration in which the pressure-sensitive adhesive layer is removed from the pressure-sensitive adhesive functional film) may be referred to as “a functional film” in some cases. In FIG. 1, a functional film may also be a laminate (having the configuration of “a functional layer/a transparent substrate”) represented by reference numeral 15.

[Transparent Substrate]

The transparent substrate of the pressure-sensitive adhesive functional film of the present invention refers to a transparent substrate. The transparent substrate is not particularly limited to, and examples thereof include a film made of plastic materials, including polyester resins such as polyethylene terephthalate (PET); acrylic resins such as polymethyl methacrylate (PMMA); polycarbonate; triacetyl cellulose (TAC); polysulfone; polyarylate; polyimide; polyvinyl chloride; polyvinyl acetate; polyethylene; polypropylene; ethylene-propylene copolymer; and cyclic olefin polymer such as trade name “ARTON (cyclic olefin polymer; manufactured by JSR)”, trade name “ZEONOR (cyclic olefin polymer; manufactured by Nippon Zeon Co., Ltd.)”. The plastic materials may be used either alone or in combination of two or more thereof. Among them, PET is preferable in terms of excellent mechanical strength and dimensional stability. In addition, the TAC is preferable in that the phase difference in the plane of the film is very little. That is, PET film (especially biaxially oriented PET film) or TAC film is preferable as a transparent substrate.

The transparent substrate may have a shape of a single layer or multilayer. On the surface of the transparent substrate, for example, a known or general surface treatment such as a physical treatment including a corona discharge treatment or a plasma treatment and a chemical treatment including a basecoat treatment may be properly preformed.

The thickness of the transparent substrate is not particularly limited, but is preferably 25 μm to 500 μm, and more preferably 40 μm to 200 μm. By setting the thickness to 25 μm or more, the handling of the pressure-sensitive adhesive functional film tends to be easy. On the other hand, by setting the thickness to 500 μm or less, the product tends to be advantageous in being small or being thin film.

The total light transmittance in a visible light wavelength region of the transparent substrate (in accordance with JIS K7361-1) is not particularly limited, but is preferably 85% or more, more preferably 87% or more, and further more preferably 90% or more. By setting the total light transmittance to 85% or more, transparency becomes excellent, and thus, the visibility or display quality of the display part of optical products and the appearance of optical products are hardly negatively affected.

The haze of the transparent substrate (in accordance with JIS K7136) is not particularly limited, but is preferably 1.5% or less, and more preferably 1.0% or less. By setting the haze to 1.5% or less, transparency becomes excellent, and thus, the visibility or display quality of the display part of optical products and the appearance of optical products are hardly negatively affected. In addition, the total light transmittance and the haze of the transparent substrate can be measured by using a haze meter (trade name “HM-150”, manufactured by Murakami Color Research Laboratory).

[Functional Layer]

The functional layer of the pressure-sensitive adhesive functional film of the present invention is selected from the group consisting of a hard coat layer and an anti-reflection layer. In the pressure-sensitive adhesive functional film of the present invention, at least one of the above functional layers is formed on one surface of a transparent substrate. The functional layer is a resin layer having a function of anti-scratch, anti-reflectivity or the like.

(Hard Coat Layer)

The hard coat layer of the pressure-sensitive adhesive functional film of the present invention has a function of improving anti-scratch (damage resistance) of the surface (the surface of the hard coat layer side) of the pressure-sensitive adhesive functional film.

The pencil hardness of the surface of the hard coat layer (the hard coat layer surface) is not particularly limited, but is preferably HB or harder, more preferably H or harder. Also, the pencil hardness can be measured by scratch hardness test (pencil method) in accordance with JIS K5600-5-4.

As the above hard coat layer, a known or general hard coat layer can be applied. The resin component forming the hard coat layer is not particularly limited to, and examples thereof include a thermosetting resin such as siloxane-based resin; an ionizing radiation curable resin (for example, UV-curable resin) produced by curing monomers or oligomers such as an ester-based monomer/oligomer, an acrylic monomer/oligomer, an urethane-based monomer/oligomer, an amide-based monomer/oligomer, a silicone-based monomer/oligomer and an epoxy-based monomer/oligomer using a photopolymerization initiator; an ionizing radiation curable resin (for example, UV-curable resin) of the monomer or oligomer hybrids such as acrylic/urethane-based monomer/oligomer and acrylic/epoxy-based monomer/oligomer. Among them, from the viewpoint of the improvement of anti-scratch, the ionizing radiation curable resin is preferable, and the UV-curable resin is more preferable. That is, the hard coat layer may be preferably a cured film cured by irradiating the ionizing radiation (especially UV) to an ionizing radiation-curable resin (especially UV-curable resin). Further, the hard coat layer may have a single layer configuration or a duplex layer (a multilayer) configuration.

The thickness of the hard coat layer is not particularly limited, but is preferably 1 μm to 50 μm, more preferably 2 μm to 30 μm, and further more preferably 2 μm to 10 μm. If the thickness is less than 1 μm, the surface hardness may not be enough, and thus, the layer may be easily damaged. If the thickness is greater than 50 μm, the cured film may become easy to be vulnerable, and tends to crack when the film is fold and bent. Further, “the thickness of the hard coat layer” refers to the sum of thicknesses of each layer in the case where the hard coat layer is in a multiple layer configuration.

The hard coat layer may be a layer having a high anti-reflectivity. Because of such a hard coat layer, the pressure-sensitive adhesive functional film of the present invention exerts both excellent anti-scratch and anti-reflectivity.

The hard coat layer may be formed by a known or general method. Specifically, for example, the hard coat layer can be formed by coating a coating solution containing a resin component forming a hard coat layer on one surface of the transparent substrate, if necessary, followed by conducting drying and/or curing.

Above all, for the purpose of reducing the interference fringes, in the coating solution, it is preferable that a solvent having a vapor pressure of 10 mmHg (13.3 hPa) or less at 25° C. is used as a diluent solvent for a resin component forming a hard coat layer, and a coating solution, in which a specific amount of a leveling agent is added to the resin component, is used.

The solvent having a vapor pressure of 10 mmHg (13.3 hPa) or less at 25° C. used as a solvent (a diluent solvent) may include isophorone, pentyl acetate, isopentyl acetate, diethylene glycol monoethyl ether, propylene glycol monomethyl ether, cyclohexanone, ethyl cellosolve or the like. Among them, ethyl cellosolve and/or cyclohexanone is preferable from the viewpoints of boiling point and industrial convenience. If the diluent solvent having a vapor pressure within a specific range is used, rapid volatilization of the diluent solvent is suppressed during the drying process after coating. As a result, the thickness unevenness of the hard coat layer is reduced, and the occurrence of the interference fringes are suppressed.

As a leveling agent, for example, the fluorine- or silicone-based leveling agent, especially the silicone-based leveling agent can be preferably used. Examples of the silicone-based leveling agent include polydimethyl siloxanes, polyether modified polydimethylsiloxane, and polymethylalkyl siloxane.

The used amount (ratio) of the leveling agent is not particularly limited, but is preferably 0.01 parts to 0.5 parts by weight, and more preferably 0.02 parts to 0.12 parts by weight based on 100 parts by weight of the resin components forming the hard coat layer. If the leveling agent is used within the above range, the leveling agent bleeds out onto the surface of the coating solution (coating film) coated to the transparent substrate, thereby equalizing the surface tension. As a result, the thickness unevenness of the hard coat layer formed is reduced, and the interference fringes hardly occur. If the amount of the leveling agent is out of the above range, it is difficult to obtain the effects.

Moreover, in the case where the resin component forming the hard coat layer is an ionizing radiation curable resin (especially, UV curable resin), if the fluorine- or silicone-based leveling agent is added thereto, the leveling agent bleeds out to the air interface during the drying process (preliminary drying or main drying as described below). Accordingly, when cured by irradiating the ionizing radiation (especially UV), the curing inhibition due to oxygen is prevented, and the sufficient hardness is exerted on the outer most surface of the hard coat layer. In addition, the slip property can be imparted thereto by bleeding-out of the silicone-based leveling agent, thereby improving the anti-scratch property.

The solid concentration of the coating solution depends on coating processes, and is not particularly limited, but is preferably 20 wt % to 50 wt %, more preferably 25 wt % to 40 wt %, when considering the viscosity of the coating solution and the amount of the solvent used for dilution, which has a vapor pressure of 10 mmHg (13.3 hPa) or less. By setting the solids concentration of the coating solution to 20 wt % to 50 wt %, the thickness unevenness of the coating film is reduced, and a suitable surface availability is obtained, and thus, the occurrence of the interference fringes are reduced.

When forming the hard coat layer, the coating solution is coated on one surface of the transparent substrate, and then dried. For this drying process, it is desirable that drying (pre-drying) is performed at a temperature of less than 80° C., and then, drying (main drying) is performed at a temperature of 80° C. or higher. If the main drying is performed at a temperature of 80° C. or higher immediately after coating, convection occurs inside of the coated layer due to a rapid volatilization of the diluent solvent in the coating solution. As a result, the hard coat layer is formed with a subtle thickness difference, and thus the interference fringes are apt to appear. If the pre-drying is performed at a temperature of less than 80° C. before the main drying, the occurrence of the interference fringes are reduced.

Conditions of pre-drying are not specifically limited, but, for example, drying is performed preferably at a temperature of less than 80° C. for 30 seconds or more, specifically, for example, at room temperature for 5 minutes, or at 40° C. for 1 minute. In particular, pre-drying is preferably performed at a temperature of 35 to 45° C. within one minute from the viewpoint of productivity. After that, the main drying is performed at a temperature of 80° C. or higher with a suitable time.

(Anti-Reflection Layer)

The anti-reflection layer in the pressure-sensitive adhesive functional film of the present invention refers to, for example, a layer that exerts an anti-reflectivity (anti-reflection function), which is achieved by allowing the phase of the incident light and the reversed phase of the reflected light to be removed each other using the interference effect of light. The anti-reflection layer has a function of improving the display quality of the display part of optical products by suppressing the reflection of the incident light from the anti-reflection layer side of the pressure-sensitive adhesive functional film.

The anti-reflection layer can be applied by a known or general wet or dry coating, which is not particularly limited. Also, for a method of forming the anti-reflection layer (film-forming method), a known or general method can be used, and is not particularly limited. The anti-reflection layer includes basically a transparent compound (preferably a metal oxide) layer, which has a smaller refractive index than that of a transparent substrate (if the transparent substrate includes an anchor coat layer or a hard coat layer, the refractive index is that of the transparent substrate including these layers), and a compound (preferably metal oxide) layer, which has a greater refractive index than that of the transparent substrate, so that the anti-reflection layer has an optical film thickness (the product of refractive index n and absolute thickness d) designed so as to minimize the whole reflectance close to a minimum value. The configuration of the anti-reflection layer differs depending on the intended use, cost, or film forming method, and is not particularly limited, and may be a single layer configuration or a multilayer configuration. Among them, the anti-reflection layer including multilayer (the anti-reflection layer of a multilayer configuration) is particularly preferable in that the reflectivity is very low, and the anti-reflectivity (anti-reflection performance) is high. In addition, the anti-reflection film may be preferably formed by a vapor deposition using electron beam heating method. More specifically, as the anti-reflection layer, for example, the anti-reflection layers disclosed in JP H09-314038 A (the anti-reflection layer by wet coating) or JP 2010-92003 A (the anti-reflection layer by dry coating) may preferably be used.

As a functional layer of the pressure-sensitive adhesive functional film of the present invention, the hard coat layer and the anti-reflection layer may have functions of anti-glare property, antifouling property, fingerprint resistant property, chemical resistant property and the like, in addition to the above-mentioned anti-scratch and anti-reflection properties. As a means for imparting the above functions, a known or general method can be used. For example, by incorporating fine particles in the functional layer, the incident light on the surface of the functional layer may be scattered, thereby exerting anti-glare property.

In addition, the functional layer of the pressure-sensitive adhesive functional film of the present invention may be a laminate structure of layers exerting functions of anti-glare property, antifouling property, fingerprint resistant property, chemical resistant property or the like. For example, the hard coat layer may be a laminate structure of a layer having excellent anti-scratch property and a layer having excellent anti-glare property (for example, a layer containing fine particles, and the like.) so as to have both excellent anti-scratch property and anti-glare property.

(Functional Film)

The total light transmittance (in accordance with JIS K7361-1) of the functional film which is a laminate of the transparent substrate and the functional layer is not particularly limited, but is preferably 85% or more, more preferably 87% or more, and further more preferably 90% or more. In addition, the haze (in accordance with JIS K7136) of the functional film is not particularly limited, but is preferably 1.5% or less, and more preferably 1.0% or less. The total light transmittance and haze can be, for example, measured by a haze meter (trade name “HM-150”, manufactured by Murakami Color Research Laboratory).

As particularly preferred specific configurations of the functional film, examples thereof include a functional film including a transparent substrate and a hard coat layer on one surface of the transparent substrate, wherein the functional film has a total light transmittance of 87% or more and a haze of 1.5% or less, and a pencil hardness on the surface of the hard coat layer is HB or harder. That is, as the particularly preferred specific configurations of the pressure-sensitive adhesive functional film of the present invention, examples thereof include a pressure-sensitive adhesive functional film including the above specific configuration of the functional film and the pressure-sensitive adhesive layer described below on the other surface of the transparent substrate which is on the side opposite to the hard coat layer. However, the pressure-sensitive adhesive functional film of the present invention is not limited thereto.

(Pressure-Sensitive Adhesive Layer)

The pressure-sensitive adhesive layer of the pressure-sensitive adhesive functional film of the present invention is formed on the other (opposite side to the functional layer) surface (i.e., surface on the side opposite to the functional layer of the functional film) of the transparent substrate. Since the pressure-sensitive adhesive functional film of the present invention has the pressure-sensitive adhesive layer, the fixing to the adherent and the handling thereof are easy.

The kind of a pressure-sensitive adhesive for forming the pressure-sensitive adhesive layer of the present invention is not particularly limited, but for example, examples thereof include a known pressure-sensitive adhesive such as an acrylic pressure-sensitive adhesive, a rubber-based pressure-sensitive adhesive, a vinylalkylether-based pressure-sensitive adhesive, a silicon-based pressure-sensitive adhesive, a polyester-based pressure-sensitive adhesive, a polyamide-based pressure-sensitive adhesive, a urethane-based pressure-sensitive adhesive, a fluorine-based pressure-sensitive adhesive, and an epoxy-based pressure-sensitive adhesive. These pressure-sensitive adhesive may be used either alone or in combination of two or more thereof. These pressure-sensitive adhesive may be an pressure-sensitive adhesive in any shape, and examples thereof include an active energy-ray curable pressure-sensitive adhesive, a solvent type (solution type) pressure-sensitive adhesive, an emulsion type pressure-sensitive adhesive, and a hot melt type pressure-sensitive adhesive.

Among the pressure-sensitive adhesive, the acrylic pressure-sensitive adhesive is preferred from the viewpoint of transparency and heat resistance. That is, the pressure-sensitive adhesive layer is preferably an acrylic pressure-sensitive adhesive layer that includes the acrylic polymer as an essential component. The amount of the acrylic polymer in the pressure-sensitive adhesive layer (acrylic pressure-sensitive adhesive layer) is not particularly limited, but is preferably 65 wt % or more (for example, 65 to 100 wt %), and more preferably 70 to 99.9 wt % based on the pressure-sensitive adhesive layer (100 wt %).

The pressure-sensitive adhesive layer (acrylic pressure-sensitive adhesive layer) varies depending on a method for forming the pressure-sensitive adhesive layer, and is not particularly limited. However, the pressure-sensitive adhesive layer is formed from an acrylic pressure-sensitive adhesive composition that includes the acrylic polymer as an essential component, or an acrylic pressure-sensitive adhesive composition that includes, as an essential component, a mixture of monomers constituting the acrylic polymer (referred to as a “monomer mixture” in some cases) or partially polymerized product thereof. Without limitation thereto, as the former acrylic pressure-sensitive adhesive, examples thereof include a so-called solvent type pressure-sensitive adhesive composition, and as the latter acrylic pressure-sensitive adhesive, examples thereof include an active energy-ray curable pressure-sensitive adhesive composition.

The “pressure-sensitive adhesive composition” includes the meaning of the “composition for forming the pressure-sensitive adhesive layer”. The “monomer mixture” means a mixture consisting of monomer components constituting the acrylic polymer. The “partially polymerized product” means a composition in which one or two or more components of the components of the monomer mixture are partially polymerized.

The acrylic polymer is a polymer that is formed from the acrylic monomer as an essential monomer component. For example, the acrylic polymer is preferably, but not particularly limited to, a polymer including, as a monomer component, alkyl ester(meth)acrylate having a linear or branched alkyl group and/or alkoxyalkyl ester(meth)acrylate having a linear or branched alkyl group and a polar group-containing monomer. The “(meth)acryl” means “acryl” and/or “methacryl” (any one or both of “acryl” and “methacryl”), and the same applies to the following.

The alkyl ester(meth)acrylate having the linear or branched alkyl group (hereinafter, simply referred to as “alkyl ester(meth)acrylate in some cases) may include, for example, alkyl ester(meth)acrylate having 1 to 20 carbon atoms such as methyl(meth)acrylate, ethyl(meth)acrylate, propyl(meth)acrylate, isopropyl(meth)acrylate, n-butyl(meth)acrylate, isobutyl(meth)acrylate, s-butyl(meth)acrylate, t-butyl(meth)acrylate, pentyl(meth)acrylate, isopentyl(meth)acrylate, hexyl(meth)acrylate, heptyl(meth)acrylate, octyl(meth)acrylate, 2-ethylhexyl(meth)acrylate, isooctyl(meth)acrylate, nonyl(meth)acrylate, isononyl(meth)acrylate, decyl(meth)acrylate, isodecyl(meth)acrylate, undecyl(meth)acrylate, dodecyl(meth)acrylate, tridecyl(meth)acrylate, tetradecyl(meth)acrylate, pentadecyl(meth)acrylate, hexadecyl(meth)acrylate, heptadecyl(meth)acrylate, octadecyl(meth)acrylate, nonadecyl(meth)acrylate and eicosyl(meth)acrylate. The alkyl ester(meth)acrylate may be used alone or in combination of two or more thereof. Among them, as the alkylester(meth)acrylate, 2-ethylhexyl acrylate (2EHA) are preferable.

The alkoxyalkyl ester(meth)acrylate (alkoxyalkyl(meth)acrylate) may include, but not particularly limited to, for example, 2-methoxyethyl(meth)acrylate, 2-ethoxyethyl(meth)acrylate, methoxytriethylene glycol(meth)acrylate, 3-methoxypropyl(meth)acrylate, 3-ethoxypropyl(meth)acrylate, 4-methoxybutyl(meth)acrylate and 4-ethoxybutyl(meth)acrylate. The alkoxyalkyl ester(meth)arylate may be used alone or in combination of two or more thereof. Among them, 2-methoxyethylacrylate (2MEA) is preferable.

The content of alkyl ester(meth)acrylate and/or alkoxyalkyl ester(meth)acrylate is not particularly limited, but is preferably 30 wt % or more (for example, 30 to 100 wt %), and more preferably 50 to 99 wt % based on the total amount (100 wt %) of monomer components constituting the acrylic polymer, from the viewpoint of low temperature adhesion property. In the case where both alkyl ester(meth)acrylate and alkoxyalkyl ester(meth)acrylate are used as the monomer component of the acrylic polymer, the total amount (total content) of the content of alkylester(meth)acrylate and the content of alkoxyalkylester(meth)acrylate may be within the above range.

In the case where both alkyl ester(meth)acrylate and alkoxyalkyl ester(meth)acrylate are used as the monomer component constituting the acrylic polymer, the content of alkoxyalkyl ester(meth)acrylate is not particularly limited, but is preferably 1 to 75 wt % and more preferably 1 to 50 wt % based on the total content thereof (100 wt %).

The polar group-containing monomer may include, for example, a hydroxyl group-containing monomer such as 2-hydroxyethyl(meth)acrylate, 3-hydroxypropyl(meth)acrylate, 4-hydroxybutyl(meth)acrylate, 6-hydroxyhexyl(meth)acrylate, vinyl alcohol and allyl alcohol; an amide group-containing monomer such as (meth)acrylamide, N,N-dimethyl(meth)acrylamide, N-methylol(meth)acrylamide, N-methoxymethyl(meth)acrylamide, N-butoxymethyl(meth)acrylamide, and N-hydroxyethyl(meth)acrylamide; an amino group-containing monomer such as aminoethyl(meth)acrylate, dimethylaminoethyl(meth)acrylate and t-butylaminoethyl(meth)acrylate; an epoxy group-containing monomer such as glycidyl(meth)acrylate and methyl glycidyl(meth)acrylate; a cyano group-containing monomer such as acrylonitrile and methacrylonitrile; a hetero ring-containing vinyl monomer such as N-vinyl-2-pyrrolidone, (meth)acryloylmorpholine, N-vinylpiperidone, N-vinylpiperazine, N-vinylpyrrole, N-vinylimidazole, vinylpyridine, vinylpyrimidine and vinyloxazole; a sulfonate group-containing monomer such as sodium vinylsulfonate; a phosphate group-containing monomer such as 2-hydroxyethylacryloyl phosphate; an imide group-containing monomer such as cyclohexylmaleimide and isopropylmaleimide; and an isocyanate group-containing monomer such as 2-methacryloyloxyethyl isocyanate. The polar group-containing monomer may be used alone or in combination of two or more thereof. Among them, the hydroxyl group-containing monomer and the hetero ring-containing vinyl monomer are preferable, and 4-hydroxybutyl acrylate is more preferable (4HBA).

The content of the polar group-containing monomer is not particularly limited, but is preferably 1 to 25 wt %, and more preferably 1 to 20 wt % based on the total amount (100 wt %) of the monomer components constituting the acrylic polymer.

Further, the monomer component forming the acrylic polymers may include monomers (also, referred to “other copolymeric monomers” in some cases) other than the above described alkyl ester(meth)acrylate, alkoxy alkyl ester(meth)acrylate and polar group-containing monomers.

As the other copolymeric monomers, for example, multifunctional monomers can be used. The multifunctional monomers mean monomers having two or more ethylenically unsaturated groups in one molecule. The ethylenically unsaturated group is not particularly limited, examples thereof include radical polymerizable functional groups such as a vinyl group, a propenyl group, an isopropenyl group, a vinylether group (vinyloxy group) and an allylether group (an allyloxy group). In addition, the alkyl ester(meth)acrylate, alkoxy alkyl ester(meth)acrylate, and polar group-containing monomer are be a monomer (monofunctional monomer) having only one ethylenically unsaturated group in one molecule.

As the polyfunctional monomer, examples thereof include hexanediol di(meth)acrylate, butanediol di(meth)acrylate, (poly)ethylene glycol di(meth)acrylate, (poly)propylene glycol di(meth)acrylate, neopentyl glycol di(meth)acrylate, pentaerythritol di(meth)acrylate, pentaerythritol tri(meth)acrylate, dipentaerythritol hexa(meth)acrylate, trimethylolpropane tri(meth)acrylate, tetramethylolmethane tri(meth)acrylate, allyl(meth)acrylate, vinyl(meth)acrylate, divinylbenzene, epoxyacrylate, polyester acrylate and urethane acrylate. The polyfunctional monomer may be used alone or in combination of two or more thereof.

The content of the polyfunctional monomer is not particularly limited, but is preferably 0.5 wt % or less (for example, 0 to 0.5 wt %) and more preferably 0 to 0.1 wt % based on the total amount (100 wt %) of the monomer components constituting the acrylic polymer. When the crosslinking agent is used, the polyfunctional monomer may not be used. However, when the crosslinking agent is not used, the content of the polyfunctional monomer is preferably 0.001 to 0.5 wt % and more preferably 0.002 to 0.1 wt %.

As the other copolymerizable monomer, in addition to the polyfunctional monomer, examples thereof include (meth)acrylate other than the above described alkylester(meth)acrylate, alkoxyalkylester(meth)acrylate, polar group-containing monomer, and functional monomer, such as (meth)acrylate having an alicyclic hydrocarbon group such as cyclopentyl(meth)acrylate, cyclohexyl(meth)acrylate and isobornyl(meth)acrylate, and (meth)acrylate having an aromatic hydrocarbon group such as phenyl(meth)acrylate, phenoxyethyl(meth)acrylate and benzyl(meth)acrylate; vinyl esters such as vinyl acetate and vinyl propionate; aromatic vinyl compounds such as styrene and vinyl toluene; olefins or dienes such as ethylene, butadiene, isoprene and isobutylene; vinyl ethers such as vinylalkyl ether; and vinyl chloride.

The content of a monomer containing a carboxylic group (carboxylic group-containing monomer) in the monomer component for forming the acrylic polymer is preferably low from the standpoint of the improvement of corrosion resistance. Specifically, the content of the carboxylic group-containing monomer is preferably less than 5 wt %, more preferably 2 wt % or less (for example, 0 to 2 wt %), and more preferably 0.5 wt % or less (for example, 0 to 0.5 wt %) based on the total amount (100 wt %) of the monomer components constituting the acrylic polymer. By setting the content to less than 5 wt %, corrosion resistance is improved. As the carboxylic group-containing monomer, examples thereof include (meth)acrylic acid, itaconic acid, maleic acid, fumaric acid, crotonic acid and isocrotonic acid. Further, acid anhydride of the carboxylic group-containing monomer (for example, the acid anhydride-containing monomer such as maleic anhydride and itaconic anhydride) is included as the carboxylic group-containing monomer.

The acrylic polymer can be prepared by polymerizing the monomer components using a known/general polymerization method. As the polymerization method of the acrylic polymer, examples thereof include a solution polymerization method, an emulsion polymerization method, a bulk polymerization method and a polymerization method by an active energy-ray irradiation (active energy-ray polymerization method). Among them, the solution polymerization method and the active energy-ray polymerization method are preferable from the standpoint of transparency, water resistance and cost.

In the solution polymerization, various kinds of general solvents can be used. Examples of such a solvent include organic solvents such as: esters such as ethyl acetate and n-butyl acetate; aromatic hydrocarbons such as toluene and benzene; aliphatic hydrocarbons such as n-hexane and n-heptane; alicyclic hydrocarbons such as cyclohexane and methylcyclohexane; and ketones such as methylethylketone and methylisobutylketone. The solvents may be used either alone or in combination of two or more thereof.

The active energy-ray irradiated in the active energy-ray polymerization (photopolymerization) is not particularly limited, and examples thereof include an alpha ray, a beta ray, a gamma ray, a neutron ray, and an ionizing radiation such as an electron ray or UV. Among them, UV is preferable. An irradiation energy, an irradiation time and an irradiation method of the active energy-ray are not particularly limited so long as the monomer components may be reacted by activating a photopolymerization initiator.

When the acrylic polymer is prepared, a polymerization initiator such as a thermal polymerization initiator and a photopolymerization initiator (photoinitiator) may be used depending on the kind of polymerization reaction. The polymerization initiator may be used alone or in combination of two or more thereof.

The thermal polymerization initiator may be particularly used when the acrylic polymer is prepared by the solution polymerization. As the thermal polymerization initiator, examples thereof include an azo initiator, a peroxide polymerization initiator (for example, dibenzoyl peroxide and tert-butyl permaleate) and a redox polymerization initiator. Among the initiators, the azo initiator disclosed in JP 2002-69411 A is particularly preferable. The azo initiator is preferable, since the decomposed product of the initiator hardly remains in the acrylic polymer as a part which causes a gas generated by heat (outgas). As the azo initiator, examples thereof include 2,2′-azobisisobutyronitrile (hereinafter, referred to as AIBN in some cases), 2,2′-azobis-2-methylbutyronitrile (hereinafter, referred to as AMBN in some cases), dimethyl 2,2′-azobis(2-methylpropionate) and 4,4′-azobis-4-cyanovaleric acid. The content of the azo initiator used is preferably 0.05 to 0.5 parts by weight, and more preferably 0.1 to 0.3 parts by weight based on 100 parts by weight of the total amount of the monomer components constituting the acrylic polymer.

The photopolymerization initiator may be particularly used when the acrylic polymer is prepared by the active energy-ray polymerization. The photopolymerization initiator may include, but not particularly limited to, for example, a benzoin ether photopolymerization initiator, an acetophenon photopolymerization initiator, an α-ketol photopolymerization initiator, an aromatic sulfonyl chloride photopolymerization initiator, a photoactive oxime photopolymerization initiator, a benzoin photopolymerization initiator, a benzyl photopolymerization initiator, a benzophenon photopolymerization initiator, a ketal photopolymerization initiator and a thioxantone photopolymerization initiator. The content of the photopolymerization initiator used is not particularly limited, but is preferably 0.01 to 0.2 parts by weight, and more preferably 0.05 to 0.15 parts by weight based on 100 parts by weight of the total amount of the monomer components constituting the acrylic polymer.

As the benzoin ether photopolymerization initiator, examples thereof include benzoin methyl ether, benzoin ethyl ether, benzoin propyl ether, benzoin isopropyl ether, benzoin isobutyl ether, 2,2-dimethoxy-1,2-diphenylethane-1-on and anisole methyl ether. As the acetophenon photopolymerization initiator, examples thereof include 2,2-diethoxyacetophenon, 2,2-dimethoxy-2-phenylacetophenon, 1-hydroxycyclohexylphenylketone, 4-phenoxydichloroacetophenon and 4-(t-butyl)dichloroacetophenon. As the α-ketol photopolymerization initiator, examples thereof include 2-methyl-2-hydroxypropiophenon and 1-[4-(2-hydroxyethyl)phenyl]-2-methylpropane-1-on. As the aromatic sulfonyl chloride photopolymerization initiator, examples thereof include 2-naphthalenesulfonyl chloride. As the photoactive oxime photopolymerization initiator, examples thereof include 1-phenyl-1,1-propanedion-2-(o-ethoxycarbonyl)-oxime. As the benzoine photopolymerization initiator, examples thereof include benzoin. As the benzyl photopolymerization initiator, examples thereof include benzyl. As the benzophenon photopolymerization initiator, examples thereof include benzophenon, benzoylbenzoate, 3,3′-dimethyl-4-methoxybenzophenon, polyvinylbenzophenon and α-hydroxycyclohexyl phenyl ketone. As the ketal photopolymerization initiator, examples thereof include benzyl dimethyl ketal. As the thioxantone photopolymerization initiator, examples thereof include thioxantone, 2-chlorothioxantone, 2-methylthioxantone, 2,4-dimethylthioxantone, isopropylthioxantone, 2,4-diisopropylthioxantone and dodecylthioxantone.

In the pressure-sensitive adhesive composition for forming the pressure-sensitive adhesive layer, if necessary, known additives such as a crosslinking agent, a crosslinking accelerator, a silane coupling agent, a tackifying resin (rosin derivative, polyterphen resin, petroleum resin, and oil-soluble phenol), an antiaging agent, a filler, a colorant (dye or pigment), a UV absorbing agent, an antioxidant, a chain-transfer agent, a plasticizer, a softener, a surfactant and an antistatic agent may be used as long as the property of the present invention is impaired. When the pressure-sensitive adhesive layer is formed, various general solvents may be used. The kind of the solvent is not particularly limited, and examples thereof include any solvents used in the solution polymerization method as described above.

By using the crosslinking agent, the acrylic polymer in the pressure-sensitive adhesive layer can be crosslinked and the gel fraction of the pressure-sensitive adhesive layer can be controlled. As the crosslinking agent, examples thereof include an isocyanate-based crosslinking agent, an epoxy-based crosslinking agent, a melamine-based crosslinking agent, a peroxide-based crosslinking agent, a urea-based crosslinking agent, a metal alkoxide-based crosslinking agent, a metal chelate-based crosslinking agent, a metal salt-based crosslinking agent, a carbodiimide-based crosslinking agent, an oxazoline-based crosslinking agent, an aziridine-based crosslinking agent and an amine-based crosslinking agent. The crosslinking agent may be used alone or in combination of two or more thereof. Among the above crosslinking agents, from the standpoint of improvement of the durability, the isocyanate-based crosslinking agent, and the epoxy-based crosslinking agent are preferable, and the isocyanate-based crosslinking agent is more preferable.

As the isocyanate-based crosslinking agent (polyfunctional isocyanate compound), examples thereof include lower aliphatic polyisocyanates such as 1,2-ethylene diisocyanate, 1,4-butylenediisocyanate and 1,6-hexamethylene diisocyanate; alicyclic polyisocyanates such as cyclopentylene diisocyanate, cyclohexylene diisocyanate, isophorone diisocyanate, hydrogenated tolylene diisocyanate and hydrogenated xylene diisocyanate; and aromatic polyisocyanates such as 2,4-tolylene diisocyanate, 2,6-tolylene diisocyanate, 4,4′-diphenylmethane diisocyanate and xylylene diisocyanate. The isocyanate-based crosslinking agent may be, for example, commercially available products such as a trimethylolpropane/tolylene diisocyanate adduct (manufactured by Nippon Polyurethane Industry Co., Ltd., trade name “CORONATE L”), a trimethylolpropane/hexamethylene diisocyanate adduct (manufactured by Nippon Polyurethane Industry Co., Ltd., trade name “CORONATE HL”), a trimethylolpropane/xylylene diisocyanate adduct (manufactured by Mitsui Chemicals Co., Ltd., trade name “TAKENATE 110N”).

As the epoxy-based crosslinking agent (polyfunctional epoxy compound), examples thereof include N,N,N′,N′-tetraglycidyl-m-xylenediamine, diglycidyl aniline, 1,3-bis(N,N-diglycidylaminomethyl)cyclohexane, 1,6-hexanediol diglycidyl ether, neopentyl glycol diglycidyl ether, ethylene glycol diglycidyl ether, propylene glycol diglycidyl ether, polyethylene glycol diglycidyl ether, polypropylene glycol diglycidyl ether, sorbitol polyglycidyl ether, glycerol polyglycidyl ether, pentaerythritol polyglycidyl ether, polyglycerol polyglycidyl ether, sorbitan polyglycidyl ether, trimethylolpropane polyglycidyl ether, adipic acid diglycidyl ester, o-phthalic diglycidyl ester, triglycidyl-tris(2-hydroxyethyl)isocyanurate, resorcin diglycidyl ether, bisphenol-5-diglycidyl ether and an epoxy-based resin having two or more epoxy groups in the molecule. The epoxy-based crosslinking agent may be, for example, commercially available products such as trade name “TETRAD C” manufactured by Mitsubishi Gas Chemical Company, Inc.

The content of the crosslinking agent in the pressure-sensitive adhesive composition is not particularly limited, but for example, is preferably 0.001 to 10 parts by weight, and more preferably 0.01 to 5 parts by weight based on the total amount (100 parts by weight) of the monomer components constituting the acrylic polymer. By setting the content to 0.001 parts by weight or more, the durability is improved. On the other hand, by setting the content to 10 parts by weight or less, the step absorbability is improved.

As the method for forming the pressure-sensitive adhesive layer, a known and general method for forming the pressure-sensitive adhesive layer may be used and it is not particularly limited, but for example, the following methods (1) to (3) may be used. (1) The pressure-sensitive adhesive layer is formed by coating a pressure-sensitive adhesive composition including a monomer mixture or partially polymerized product and, if necessary, an additive such as a photopolymerization initiator or a crosslinking agent, on a transparent substrate or a release liner, and irradiating active energy-ray (in particular, UV is preferable) thereto. (2) The pressure-sensitive adhesive layer is formed by coating a pressure-sensitive adhesive composition (solution) including an acrylic polymer, a solvent, if necessary, an additive such as a crosslinking agent, on a transparent substrate or a release liner, and drying and/or curing the composition. (3) The pressure-sensitive adhesive layer formed in (1) is further dried.

In the method for forming the pressure-sensitive layer, coating may be performed by a known coating method and using, for example, a general coater (a gravure roll coater, a reverse roll coater, a kiss roll coater, a dip roll coater, a bar coater, a knife coater, a spray coater, a comma coater and a direct coater).

The thickness of the pressure-sensitive adhesive layer is not particularly limited, but is preferably 10 μm to 500 μm, and more preferably 10 μm to 250 μm. By setting the thickness to 10 μm or more, it is likely that the stress generated during laminating is distributed. Therefore, release hardly occurs, and thus, the durability is improved. The step absorbability is also improved. On the other hand, by setting the thickness to 500 μm or less, crimps are hardly formed when winding after coating.

[Pressure-Sensitive Adhesive Functional Film]

The pressure-sensitive adhesive functional film of the present invention may have other layers (for example, an intermediate layer, a base coat layer (anchor coat layer), and the like) within a range which does not damage the effects of the present invention, in addition to the transparent substrate, the functional layer and the pressure-sensitive adhesive layer.

The pressure-sensitive adhesive surface of the pressure-sensitive adhesive functional film of the present invention may be protected by a release liner (separator) until it is used. The release liner is used as a protective material of the pressure-sensitive adhesive layer, and peeled when the pressure-sensitive adhesive functional film is laminated to the adherend. The release liner may not be provided. Any known release paper may be used as a separator. The release liner may be, but not particularly limited to, for example, a release liner having a release treated layer, a low adhesive substrate composed of a fluorine polymer, or a low adhesive substrate composed of a non-polar polymer. As the release liner having the release treated layer, examples thereof include a plastic film or paper whose surface is treated by a release agent such as silicon type, long-chain alkyl type, fluorine type, and molybdenum sulfide. As the fluorine-based polymer, examples thereof include polytetrafluoroethylene, polychlorotrifluoroethylene, polyvinyl fluoride, polyvinylidene fluoride, a tetrafluoroethylene-hexafluoropropylene copolymer and a chlorofluoroethylene-vinylidene fluoride copolymer. As the non-polar polymer, examples thereof include an olefine-based resin (for example, polyethylene, polypropylene and the like). The release liner can be formed by using a known/general method. The thickness of the release liner is not particularly limited.

The transmittance curves used in the present invention is obtained by using the spectral transmittance meter [manufactured by Murakami Color Research Laboratory Co., Ltd, trade name “DOT-3UV-VIS-type”].

The pressure-sensitive adhesive functional film of the present invention has an “approximate integral value” of 50 or less as calculated using the transmittance curves measured at a wavelength of 400 to 780 nm by the spectral transmittance meter [manufactured by Murakami Color Research Laboratory Co., Ltd, trade name “DOT-3UV-VIS-type”]. The “approximate integral value” of the pressure-sensitive adhesive functional film of the present invention is 50 or less, and is not particularly limited, but is preferably 40 or less, and more preferably 30 or less. By controlling the “approximate integral value” to 50 or less, the occurrence of the interference fringes in the pressure-sensitive adhesive functional film is suppressed. The lower limit of the “approximate integral value” is not particularly limited, and it is most preferred that the “approximate integral value” is 0, but the “approximate integral value” may be 1 or more (for example, 1 to 50). Also, the “approximate integral value” can be measured by the following order.

First, the transmittance of the pressure-sensitive adhesive functional film is measured by a spectral transmittance meter [manufactured by Murakami Color Research Laboratory Co., Ltd, trade name “DOT-3UV-VIS-type”] under the following conditions:

<Measurement Conditions>

measurement wavelength: 400 nm to 780 nm

measurement wavelength interval: 5 nm

Subsequently, the “approximate integral value” is calculated from the transmittance values measured at the wavelength range of 400 to 780 nm and at the wavelength interval of 5 nm in the following order of [1] to [5].

In addition, in the present specification, the curve representing the relationship of the wavelength (abscissa: x-axis) vs. the transmittance (ordinate: y-axis) [a curve connecting each point of (wavelength, transmission)] is referred to as “transmission curve” (see, for example, FIG. 2). Further, the “points (each point)” refers to the points in which the measurement wavelength is represented as x value, and the transmittance is represented as y value (measurement wavelength, transmittance measurements).

(Calculation Method of the “Approximate Integral Value”)

[1] First, the top peak and bottom peak in the transmittance curve are determined.

The top peak is defined as a point in which the transmittance measurement (y value) is larger than that of one previous point in the x-axis direction of the transmittance curve (i.e., the point in which the measurement wavelength (x value) is smaller by 5 nm) and the transmittance measurement (y value) is greater than that of one subsequent point in the x-axis direction of the transmittance curve (i.e., the point in which the measurement wavelength (x value) is larger by 5 nm). The top peak is the approximate maximum point in the transmission curve.

The bottom peak is defined as a point in which the transmittance measurement (y value) is smaller than that of one previous point in the x-axis direction of the transmittance curve (i.e., the point in which the measurement wavelength (x value) is smaller by 5 nm) and the transmittance measurement (y value) is smaller than that of one subsequent point in the x-axis direction of the transmittance curve (i.e., the point in which the measurement wavelength (x value) is larger by 5 nm). The bottom peak is the approximate minimum point in the transmission curve.

Normally, there are a plurality of top peaks and bottom peaks.

In addition, if necessary, a peak existing out of the wavelength range of 450 nm to 750 nm (the top or bottom peak in the wavelength smaller than 450 nm or greater than 750 nm) is also specified.

[2] The average value between the adjacent top peak and bottom peak in the x-axis direction (the average value of the transmittance of the adjacent top peak and bottom peak) is calculated.

[3] The difference between the transmittance measurements (y value) at each measurement wavelength (x value) and the average value as calculated in the above [2] is calculated. That is, the difference, in which the average obtained in the above [2] is subtracted from y value at each point in the transmittance curve, is calculated.

Moreover, in the calculation of the difference, the average value of the “one peak (top peak or bottom peak)” and the “one subsequent peak in the x-axis direction (top peak or bottom peak)” is used to calculate the point (but, not including “one subsequent peak in the x-axis direction”) from one peak (top peak or bottom peak) to one subsequent peak in the x-axis direction (top peak or bottom peak).

That is, a difference corresponding to each point is obtained.

[4] The square of the difference obtained in the above [3] is calculated.

[5] The sum of the values obtained in the above [4] (squared value) related to the points in the measurement wavelength (x value) from 450 nm to 750 nm is calculated. In addition, the sum is multiplied by 5 (nm) to obtain the “approximate integral value”.

That is, the “approximate integral value” is calculated by the following equation.

“Approximate integral value”=Σ[the values obtained in [4]×5]

In addition, if no peak exists in the wavelength range of 400 nm to 450 nm, as “the average value of the transmittances at the adjacent top peak and bottom peak” at the point (provided that “450 nm adjacent peaks” is not included) from the peak having measurement wavelength of 450 nm to the peak having measurement wavelength of greater than 450 nm and closest to 450 nm (referred to as “450 nm adjacent peak”), the average value of the transmittances of the “450 nm adjacent peak” and the “one subsequent peak to the 450 nm adjacent peak in the x-axis direction” is adopted. Likewise, if no peak exists in the wavelength range of 750 nm to 780 nm, as “the average value of the transmittances at the adjacent top peak and bottom peak” at the point from the peak having measurement wavelength of less than 750 nm and closest to 750 nm (“750 nm adjacent peak”) to the peak having measurement wavelength of 750 nm, the average value of the transmittances of the “750 nm adjacent peak” and the “one previous peak to 750 nm adjacent peak in the x-axis direction” is adopted.

### Exemplary Embodiment

The calculation method of the “approximate integral value” will be described in more detail, based on the results of the transmittance measurements of the pressure-sensitive adhesive functional film obtained in Example 1. In Table 1, some of the data of the measured transmittance of the pressure-sensitive adhesive functional film obtained in Example 1 (transmittance measurements at a wavelength range of 400 to 780 nm) are represented. In addition, as shown in Table 1, points at the wavelengths from 400 nm to 780 nm have been called out as point 1, point 2, point 3, . . . , and point 77 in the order from a small wavelength side. Further, in FIG. 2, the measured transmittance curve of the pressure-sensitive adhesive functional film obtained in Example 1 (x-axis means wavelength, y-axis means transmittance) is represented. Hereinafter, it will be described based on data shown in Table 1.

TABLE 1

| | Wavelength | Transmittance | Average value of top | Measurement- | (Measurement- | ∫ (Measurement- | Remarks |
|---|---|---|---|---|---|---|---|
| | (nm) | (%) | peak and bottom peak | Average | Average)² | Average)² | (peak) |
| Point 1 | 400 | 86.70 | — | — | — | — | — |
| Point 2 | 405 | 86.71 | — | — | — | — | — |
| Point 3 | 410 | 87.13 | — | — | — | — | — |
| Point 4 | 415 | 87.60 | — | — | — | — | — |
| Point 5 | 420 | 87.51 | — | — | — | — | — |
| Point 6 | 425 | 87.79 | — | — | — | — | — |
| Point 7 | 430 | 88.24 | — | — | — | — | — |
| Point 8 | 435 | 88.17 | — | — | — | — | — |
| Point 9 | 440 | 88.16 | — | — | — | — | — |
| Point 10 | 445 | 88.57 | — | — | — | — | — |
| Point 11 | 450 | 88.65 | 88.53 | 0.12 | 0.0144 | 0.072 | T₁ |
| Point 12 | 455 | 88.52 | 88.53 | −0.01 | 0.0001 | 0.0005 | — |
| Point 13 | 460 | 88.41 | 88.705 | −0.295 | 0.087025 | 0.435125 | B₁ |
| Point 14 | 465 | 88.88 | 88.705 | 0.175 | 0.030625 | 0.153125 | — |
| Point 15 | 470 | 89.00 | 88.935 | 0.065 | 0.004225 | 0.021125 | T₂ |
| Point 16 | 475 | 88.94 | 88.935 | 0.005 | 0.000025 | 0.000125 | — |
| Point 17 | 480 | 88.87 | 89.085 | −0.215 | 0.046225 | 0.231125 | B₂ |
| Point 18 | 485 | 89.21 | 89.085 | 0.125 | 0.015625 | 0.078125 | — |
| Point 19 | 490 | 89.30 | 89.17 | 0.13 | 0.0169 | 0.0845 | T₃ |
| Point 20 | 495 | 89.16 | 89.17 | −0.01 | 0.0001 | 0.0005 | — |
| Point 21 | 500 | 89.04 | 89.27 | −0.23 | 0.0529 | 0.2645 | B₃ |
| Point 22 | 505 | 89.27 | 89.27 | 0 | 0 | 0 | — |
| Point 23 | 510 | 89.50 | 89.33 | 0.17 | 0.0289 | 0.1445 | T₄ |
| Point 24 | 515 | 89.36 | 89.33 | 0.03 | 0.0009 | 0.0045 | — |
| Point 25 | 520 | 89.16 | 89.435 | −0.275 | 0.075625 | 0.378125 | B₄ |
| Point 26 | 525 | 89.25 | 89.435 | −0.185 | 0.034225 | 0.171125 | — |
| Point 27 | 530 | 89.54 | 89.435 | 0.105 | 0.011025 | 0.055125 | — |
| Point 28 | 535 | 89.71 | 89.535 | 0.175 | 0.030625 | 0.153125 | T₅ |
| Point 29 | 540 | 89.56 | 89.535 | 0.025 | 0.000625 | 0.003125 | — |
| Point 30 | 545 | 89.36 | 89.535 | −0.175 | 0.030625 | 0.153125 | — |
| Point 31 | 550 | 89.36 | 89.605 | −0.245 | 0.060025 | 0.300125 | B₅ |
| Point 32 | 555 | 89.60 | 89.605 | −0.005 | 0.000025 | 0.000125 | — |
| Point 33 | 560 | 89.84 | 89.605 | 0.235 | 0.055225 | 0.276125 | — |
| Point 34 | 565 | 89.85 | 89.645 | 0.205 | 0.042025 | 0.210125 | T₆ |
| Point 35 | 570 | 89.65 | 89.645 | 0.005 | 0.000025 | 0.000125 | — |
| Point 36 | 575 | 89.45 | 89.645 | −0.195 | 0.038025 | 0.190125 | — |
| Point 37 | 580 | 89.44 | 89.745 | −0.305 | 0.093025 | 0.465125 | B6 |
| Point 38 | 585 | 89.72 | 89.745 | −0.025 | 0.000625 | 0.003125 | — |
| Point 39 | 590 | 89.97 | 89.745 | 0.225 | 0.050625 | 0.253125 | — |
| Point 40 | 595 | 90.05 | 89.76 | 0.29 | 0.0841 | 0.4205 | T7 |
| Point 41 | 600 | 89.83 | 89.76 | 0.07 | 0.0049 | 0.0245 | — |
| Point 42 | 605 | 89.60 | 89.76 | −0.16 | 0.0256 | 0.128 | — |
| Point 43 | 610 | 89.47 | 89.84 | −0.37 | 0.1369 | 0.6845 | B7 |
| Point 44 | 615 | 89.58 | 89.84 | −0.26 | 0.0676 | 0.338 | — |
| Point 45 | 620 | 89.93 | 89.84 | 0.09 | 0.0081 | 0.0405 | — |
| Point 46 | 625 | 90.17 | 89.84 | 0.33 | 0.1089 | 0.5445 | — |
| Point 47 | 630 | 90.21 | 89.87 | 0.34 | 0.1156 | 0.578 | T8 |
| Point 48 | 635 | 89.98 | 89.87 | 0.11 | 0.0121 | 0.0605 | — |
| Point 49 | 640 | 89.76 | 89.87 | −0.11 | 0.0121 | 0.0605 | — |
| Point 50 | 645 | 89.56 | 89.87 | −0.31 | 0.0961 | 0.4805 | — |
| Point 51 | 650 | 89.53 | 89.915 | −0.385 | 0.148225 | 0.741125 | B8 |
| Point 52 | 655 | 89.82 | 89.915 | −0.095 | 0.009025 | 0.045125 | — |
| Point 53 | 660 | 90.15 | 89.915 | 0.235 | 0.055225 | 0.276125 | — |
| Point 54 | 665 | 90.29 | 89.915 | 0.375 | 0.140625 | 0.703125 | — |
| Point 55 | 670 | 90.30 | 89.875 | 0.425 | 0.180625 | 0.903125 | T9 |
| Point 56 | 675 | 90.11 | 89.875 | 0.235 | 0.055225 | 0.276125 | — |
| Point 57 | 680 | 89.74 | 89.875 | −0.135 | 0.018225 | 0.091125 | — |
| Point 58 | 685 | 89.47 | 89.875 | −0.405 | 0.164025 | 0.820125 | — |
| Point 59 | 690 | 89.45 | 89.885 | −0.435 | 0.189225 | 0.946125 | B9 |
| Point 60 | 695 | 89.62 | 89.885 | −0.265 | 0.070225 | 0.351125 | — |
| Point 61 | 700 | 89.85 | 89.885 | −0.035 | 0.001225 | 0.006125 | — |
| Point 62 | 705 | 90.14 | 89.885 | 0.255 | 0.065025 | 0.325125 | — |
| Point 63 | 710 | 90.32 | 89.73 | 0.59 | 0.3481 | 1.7405 | T10 |
| Point 64 | 715 | 90.30 | 89.73 | 0.57 | 0.3249 | 1.6245 | — |
| Point 65 | 720 | 89.94 | 89.73 | 0.21 | 0.0441 | 0.2205 | — |
| Point 66 | 725 | 89.55 | 89.73 | −0.18 | 0.0324 | 0.162 | — |
| Point 67 | 730 | 89.30 | 89.73 | −0.43 | 0.1849 | 0.9245 | — |
| Point 68 | 735 | 89.14 | 89.71 | −0.57 | 0.3249 | 1.6245 | B10 |
| Point 69 | 740 | 89.16 | 89.71 | −0.55 | 0.3025 | 1.5125 | — |
| Point 70 | 745 | 89.26 | 89.71 | −0.45 | 0.2025 | 1.0125 | — |
| Point 71 | 750 | 89.49 | 89.71 | −0.22 | 0.0484 | 0.242 | — |
| Point 72 | 755 | 89.89 | — | — | — | — | — |
| Point 73 | 760 | 90.18 | — | — | — | — | — |
| Point 74 | 765 | 90.28 | — | — | — | — | T11 |
| Point 75 | 770 | 89.98 | — | — | — | — | — |
| Point 76 | 775 | 89.66 | — | — | — | — | — |
| Point 77 | 780 | 89.30 | — | — | — | — | — |

First, the top peaks T₁, T₂, . . . , T₁₁) and the bottom peaks (B₁, B₂, . . . , B₁₀) are determined from the results of the transmittance measurements (transmittance curve: FIG. 2). In FIG. 2, the determined top peaks and bottom peaks are represented. In addition, in Table 1, for the points corresponding to the top peaks or bottom peaks, the corresponding codes (T₁, T₂, . . . , T₁₁; B₁, B₂, . . . , B₁₀) are shown in “Remarks” column.

Specifically, for example, point 11 corresponds to the top peak (T₁) because point 11 has a greater transmittance measurement than those of previous point 10 and subsequent point 12. In addition, point 13 corresponds to the bottom peak (B₁) because point 13 has a smaller transmittance measurement than those of previous point 12 and subsequent point 14.

[2] Among the top peaks (T₁, T₂, . . . , T₁₁) and the bottom peaks (B₁, B₂, . . . , B₁₀) determined in the above [1], the average values (average values of transmittance measurements) of the adjacent top peak and bottom peak in the x-axis direction are calculated. Moreover, the above calculated average values are given in the column of “Average value of top peak and bottom peak” in Table 1.

Specifically, for example, the average value (89.87) of the transmittance measurement (90.21) of T₈ (point 47) and the transmittance measurement (89.53) of B₈ (point 51) is defined as “Average value of top peak and bottom peak” of from the point 47 (T₈) to the point 50 (one previous point of B₈).

[3] For each point (point 11 to point 71) in the measurement wavelength (x value) from 450 nm to 750 nm, the difference is obtained by subtracting “Average value of top peak and bottom peak” obtained in the above [2] from the transmittance measurement. In addition, the above calculated values (difference) are shown in the “Measurement−Average” column in Table 1.

Specifically, for example, in the calculation of the subtraction of point 47 (T₈), point 48, point 49 and point 50 (one previous point of B₈), as “Average value of top peak and bottom peak”, the average value (89.87) of the transmittance measurement of T₈ and the transmittance measurement of B₈ is used.

In addition, in the calculation of the subtraction of point 68, point 69, point 70 and point 71, the average value (89.71) of the transmittance measurement (89.14) of point 68, which is B₁₀, (wavelength of 735 nm) and the transmittance measurement (90.28) of point 74, which is T₁₁, (wavelength of 765 nm) is used as “Average value of top peak and bottom peak”.

[4] For each point (point 11 to point 71) in the measurement wavelength (x value) from 450 nm to 750 nm, the square of the difference value obtained from the above [3] is calculated. In addition, the above calculated values (the square of the difference) are shown in the “(Measurement−Average)²” column in Table 1.

[5] For each point (point 11 to point 71) having the measurement wavelength (x value) from 450 nm to 750 nm, the value of multiplying the square of the subtraction value obtained from the above [4] by 5 was calculated. In addition, the above calculated values (the value of multiplying the square of the difference by 5) are given in the “∫(measurement−average)²” column in Table 1.

In addition, for each point (point 11 to point 71) in the measurement wavelength (x value) from 450 nm to 750 nm, the sum of the above calculated value (the value of multiplying the square of the difference by 5) is calculated. The sum, 22.0, is the “approximate integral value” of the pressure-sensitive adhesive functional film obtained in Example 1.

The value of the “approximate integral value” calculated in the above order represents an indication of ease in the occurrence of the interference fringes in the pressure-sensitive adhesive functional film. More specifically, if the “approximate integral value” is great, the transmittance unevenness at the wavelength of 450 to 750 nm is large, and thus, the interference fringes occur easily. On the other hand, if the “approximate integral value” is small, especially the transmittance unevenness at the wavelength of 450 to 750 nm is small, and thus, the occurrence of interference fringes is suppressed.

The total amount of the acrylic acid ion and methacrylic acid ion extracted from the pressure-sensitive adhesive functional film of the present invention with pure water under the condition of 100° C. and 45 min (amount of the extracted (meth)acrylic acid ion), which is measured by an ion chromatograph method, is 20 ng/cm² or less (for example, 0 to 20 ng/cm²), more preferably 0 to 17 ng/cm², and more preferably 0 to 15 ng/cm² per unit area of the pressure-sensitive adhesive layer of the pressure-sensitive adhesive function film of the present invention. The amount of the extracted (meth)acrylic acid ion shows the degree of easiness of dissociation of the acrylic acid ion and methacrylic acid ion by moisture from the pressure-sensitive adhesive layer in the case where the pressure-sensitive adhesive functional film of the present invention is put under the humidified environment. By setting the amount of extracted (meth)acrylic acid ion to 20 ng/cm² or less, even though the pressure-sensitive adhesive functional film is stored in the presence of moisture such as the humidified environment in a state where the sheet is laminated to a thin film of a metal or metal oxide, or the like, the thin film is hardly corroded and the corrosion resistance is improved.

The “total amount of the acrylic acid ion and methacrylic acid ion extracted from the pressure-sensitive adhesive functional film of the present invention with pure water under the condition of 100° C. and 45 min, which is measured by the ion chromatograph method”, can be measured by using the following method.

First, the pressure-sensitive adhesive functional film is cut into an appropriate size, and in the case where the release liner is provided, the release liner is peeled, and surface of the pressure-sensitive adhesive layer (referred to as “pressure-sensitive adhesive surface” in some cases) is exposed, thereby preparing a sample. The size of the sample (exposure area of the pressure-sensitive adhesive surface) is preferably 100 cm².

Subsequently, the sample is put into pure water having a temperature of 100° C., followed by boiling for 45 min, and boiling extraction of the acrylic acid ion and methacrylic acid ion is performed.

Subsequently, the total amount (unit: ng) of the acrylic acid ion and methacrylic acid ion in the obtained extraction solution is measured by using the ion chromatograph method (ion chromatography), and the total amount (unit: ng/cm²) of the acrylic acid ion and methacrylic acid ion per unit area of the pressure-sensitive adhesive surface (exposed pressure-sensitive adhesive surface) of the sample is calculated. The measuring condition of the ion chromatograph method (ion chromatography) is not particularly limited, but for example, may be the following condition.

(Measurement Conditions of Ion Chromatograph Method)

Analysis device: DX-320, manufactured by DIONEX Co., Ltd.

Separation column: Ion Pac AS15 (4 mm×250 mm)

Guard column: Ion Pac AG15 (4 mm×50 mm)

Removal system: ASRS-ULTRA (External mode, 100 mA)

Detector: electric conductivity detector

Eluent:
7 mM KOH (0 to 20 min)
45 mM KOH (20 to 30 min)
(eluent generator EG40 is used)

Flow rate of eluent: 1.0 ml/min

Injection amount of sample: 250 μl

The (meth)acrylic acid ion dissociated by moisture from the pressure-sensitive adhesive functional film generally comes from the (meth)acrylic acid existing in the pressure-sensitive adhesive layer. It is assumed that the reason is that the (meth)acrylic acid ion disturbs conduction by penetrating the metal thin film due to moisture under the high temperature and high humidity environment, thereby causing an increase in resistance of the metal thin film (corrosion of the metal thin film). In general, in the case where a large amount (for example, 10 wt % or more) of (meth)acrylic acid (in particular, acrylic acid) is used as the monomer component constituting the acrylic polymer for the purpose of improving the adhesion property of the pressure-sensitive adhesive functional film, unreacted (meth)acrylic acid easily remains in the pressure-sensitive adhesive layer, so that the (meth)acrylic acid ion dissociated by moisture from the pressure-sensitive adhesive functional film is also increased. On the other hand, in the present invention, by sufficiently performing drying at the time of forming the pressure-sensitive adhesive layer, increasing the polymerization time of the acrylic polymer, or decreasing the amount of (meth)acrylic acid used as the monomer component, the (meth)acrylic acid ion dissociated by moisture from the pressure-sensitive adhesive functional film is decreased, so that corrosion of the adherend or increase in resistance, which are caused thereby, is suppressed.

The total light transmittance in the visible wavelength region of the pressure-sensitive adhesive functional film of the present invention (in accordance with JIS K7361-1) is not particularly limited, but is preferably 87% or more, more preferably 89% or more. By setting the total light transmittance to 87% or more, the visibility or display quality of the display part of optical products and the appearance of optical products are hardly negatively affected. Also, the total light transmittance can be calculated by, for example, a haze meter (trade name “HM-150”, manufactured by Murakami Color Research Laboratory Co., Ltd.).

The haze of the pressure-sensitive adhesive functional film of the present invention (in accordance with JIS K7136) is not particularly limited, but is preferably 1.5% or less, more preferably 1.0% or less. By setting the haze to 1.5% or less, the visibility or display quality of the display part of optical products and the appearance of optical products are hardly negatively affected. Also, the haze can be calculated by, for example, a haze meter (trade name “HM-150”, manufactured by Murakami Color Research Laboratory Co., Ltd.).

The 180° peeling pressure-sensitive adhesive force at 23° C. of the pressure-sensitive adhesive functional film (the pressure-sensitive adhesive surface of the pressure-sensitive adhesive functional film) of the present invention to the glass is not particularly limited, but is preferably 1 N/20 mm to 30 N/20 mm, and more preferably 5 N/20 mm to 20 N/20 mm. By setting the 180° peeling pressure-sensitive adhesive force to 1 N/20 mm or more (especially, 5 N/20 mm or more), the pressure-sensitive adhesive functional film can be firmly fixed to the adherent (for example, the transparent conductive film surface of the conductive film or glass lenses), and thus, the quality or durability of proecuts is improved. Further, the 180° peeling pressure-sensitive adhesive force at 23° C. can be measured by a 180° peeling test (in accordance with JIS Z0237 (2000), tensile speed: 300 mm/min) using a glass as an adherent.

The pressure-sensitive adhesive functional film of the present invention can be prepared by a known or general method. More specifically, the pressure-sensitive adhesive functional film of the present invention may be prepared by forming a functional layer (for example, hard coat layer) on one surface of the transparent substrate using the above-described method, and forming a pressure-sensitive adhesive layer on the other surface of the transparent substrate using the above-described method. In addition, the formation of the pressure-sensitive adhesive layer may be preferably performed by a method (direct scan technique) of directly forming a pressure-sensitive adhesive layer on the surface of the transparent substrate, or by a method (transfer technique) of forming a pressure-sensitive adhesive layer on a release liner and transferring (laminating) it to the transparent substrate, and then forming a pressure-sensitive adhesive layer on the surface of the transparent substrate. Also, the order of the formation of the functional layer and the pressure-sensitive adhesive layer on the transparent substrate is not particularly limited.

In addition, the pressure-sensitive adhesive functional film of the present invention can be prepared by forming a pressure-sensitive adhesive layer on one side (the side opposite to the functional layer) of a commercially available functional film. Similarly, the pressure-sensitive adhesive functional film can be prepared by forming a functional layer on one side (the side opposite to the pressure-sensitive adhesive layer) of a commercially available single-sided pressure-sensitive adhesive sheet (having the configuration of “transparent substrate/pressure-sensitive adhesive layer”).

The pressure-sensitive adhesive functional film of the present invention is not particularly limited in use, but is used in a wide range of applications, especially in optical uses such as the manufacture of optical products or optical members.

The optical products refer to products utilizing an optical characteristic (for example, a polarizing property, a photorefractive property, a light scattering property, a light reflective property, a light transmitting property, a light absorbing property, a light diffractive property, an optical rotation property and visibility). As the optical products, examples thereof include a liquid crystal display device, an organic electro luminescence (EL) display device, plasma display panel (PDP), a display device such as electronic paper or an input device such as a touch panel, or a properly combined device of the display device and the input device, or the like.

The optical member refers to a member having the above optical characteristic. As the optical member, examples thereof include a member making up devices (optical devices) such as a display device (an image display device) and an input device, and a member used in these devices. Examples thereof include a polarizing plate, a wave plate, a retardation plate, an optical compensation film, a brightness enhancing film, a light guide plate, a reflective film, an anti-reflective film, a transparent conductive film (for example, ITO film), a design film, a decoration film, a surface protective film, a prism, lens, a color filter, a transparent substrate, and a member in which these are laminated (collectively referred to as “an optical film” in some cases). Each of the “plate” and the “film” include a plate shape, a film shape, and a sheet shape, and for example, the “polarizing film” includes a “polarizing plate” and a “polarizing sheet”. In addition, the “optical member” of the present invention includes a member having a role of decorating or protecting (a design film, a decorative film, a surface protection film, etc.), while maintaining the visibility or excellent appearance of the display part of display devices or input devices.

A material constituting the optical member is not particularly limited, and examples thereof include glass, an acrylic resin, polycarbonate, and polyethylene terephthalate, and metal (including metal oxide).

A display device including the pressure-sensitive adhesive functional film of the present invention can be obtained by manufacturing the display device using an optical member having the pressure-sensitive adhesive functional film of the present invention or the pressure-sensitive adhesive functional film of the present invention.

In particular, when the functional layer of the pressure-sensitive adhesive functional film of the present invention is a hard coat layer, that is, when the pressure-sensitive adhesive functional film of the present invention is “a pressure-sensitive adhesive hard coat film”, it can be preferably used for the purpose of protecting transparent electrode in a manufacture of an electric capacity type touch panel (touch panel module), or the purpose of preventing the glass scattering of an electric capacity type touch panel (touch panel module). However, it is not limited thereto.

### EXAMPLES

Hereinafter, the present invention will be described in detail based on the Examples, but the present invention is not limited to the Examples.

### Example 1

### Preparation of the Hard Coat Film

### Functional Film

As a transparent substrate (transparent substrate film), polyethylene terephthalate film (trade name “A4300”, manufactured by Toyobo Co., Ltd.) having a thickness of 125 μm was used. Also, the coating solution for the hard coat layer (transparent hard coat layer) was prepared as follows.

The coating solution of the hard coat layer was prepared by mixing 100 parts by weight of a UV-curable resin (trade name “KRX571-76NL”, manufactured by ADEKA Corp.) with 0.5 parts by weight of silicon-based leveling agent, diluting the mixture with ethyl cellosolve at a vapor pressure of 5.3 mmHg (7.0 hPa) at 25° C., and adjusting the solids concentration to 40 wt %.

Subsequently, the coating solution was coated with #16 wire bar on one surface of the transparent substrate film so as to have a film thickness after drying of 7 μm. And then, a pre-drying was performed at 25° C. for 5 minutes, and after that, a main drying was performed at 80° C. for 3 minutes. After that, the hard coat film (transparent hard coat film) was formed by irradiating UV light with an accumulated light intensity of 300 mJ/cm² or more using a high-pressure mercury lamp, thereby performing a curing to form a hard coat layer.

Further, the hard coat film (functional film) has a total light transmittance of 91.3%, and a haze of 0.8%.

[Preparation of the Pressure-Sensitive Adhesive Layer (Pressure-Sensitive Adhesive Sheet)]

70 parts by weight of 2-methoxyethyl acrylate, 29 parts by weight of 2-ethylhexyl acrylate and 1 part by weight of 4-hydroxybutyl acrylate as monomer components, and 150 parts by weight of ethyl acetate as a polymerization solvent were put into the separable flask, followed by stirring for 1 hour while nitrogen gas was introduced. After oxygen in the polymerization system was removed thereby, the system was heated to 63° C., 0.2 parts by weight of 2,2′-azobisisobutyronitrile as a polymerization initiator was added thereto, and followed by reacting for 10 hours. And thereafter, methyl ethyl ketone (MEK) was added thereto to obtain the acrylic polymer solution having a solid concentration of 25 wt %. The weight average molecular weight of the acrylic polymer in the acrylic polymer solution was 1,000,000.

The pressure-sensitive adhesive composition (solution) was prepared by adding to the acrylic polymer solution, based on 100 parts by weight of the acrylic polymer, 0.3 parts by weight of the aliphatic isocyanate compound (trade name “DURANATE MFA-75X”, manufactured by Asahi Kasei Chemicals Corp.) as a crosslinking agent, and 0.1 parts by weight of polyol in which propylene oxide was added to ethylene diamine (trade name “EDP-300”, manufactured by ADEKA Corp.) as a crosslinking accelerator.

Next, the pressure-sensitive adhesive composition was cast-coated on the release-treated surface of the polyethylene terephtalate (PET) film (release liner) (the thickness of 38 μm) so that the thickness after drying was about 25 μm, followed by heating and drying at 130° C. for 3 minutes, and then, aging was performed at 23° C. for 7 days to obtain a substrateless pressure-sensitive adhesive sheet (transparent pressure-sensitive adhesive sheet).

[Preparation of the Pressure-Sensitive Adhesive Hard Coat Film]

The pressure-sensitive adhesive hard coat film (pressure-sensitive adhesive functional film) was prepared by laminating the hard coat film (functional film) obtained above and the substrateless pressure-sensitive adhesive sheet in the form where the pressure-sensitive adhesive layer of the pressure-sensitive adhesive sheet was contacted with the surface of the hard coat film on the side opposite to the hard coat layer, with the use of a laminator.

### Example 2

The pressure-sensitive adhesive hard coat film was prepared in the same manner as in Example 1, except that the added amount of the leveling agent was changed to 0.04 parts by weight, and the solids concentration of the coating solution was changed to 30 wt % by dilution with ethyl cellosolve in the preparation of the hard coat film (functional film).

In Example 2, the total light transmittance of the prepared hard coat film (functional film) was 91.3%, and the haze was 0.7%.

### Example 3

The pressure-sensitive adhesive hard coat film was prepared in the same manner as in Example 1, except that the added amount of the leveling agent was changed to 0.06 parts by weight and the solids concentration of the coating solution was changed to 30 wt % by dilution with ethyl cellosolve in the preparation of the hard coat film (functional film).

In Example 3, the total light transmittance of the prepared hard coat film (functional film) was 91.4%, and the haze was 0.8%.

### Example 4

The pressure-sensitive adhesive hard coat film was prepared in the same manner as in Example 1, except that the added amount of the leveling agent was changed to 0.25 parts by weight and the solids concentration of the coating solution was changed to 30 wt % by dilution with ethyl cellosolve in the preparation of the hard coat film (functional film).

In Example 4, the total light transmittance of the prepared hard coat film (functional film) was 91.3%, and the haze was 0.8%.

### Example 5

The pressure-sensitive adhesive hard coat film was prepared in the same manner as in Example 1, except that the preparation method of the coating solution was changed as follows in the preparation of the hard coat film (functional film).

The coating solution was prepared by mixing 100 parts by weight of a UV-curable resin (trade name “KRX571-76NL”, manufactured by ADEKA Corp.) with 0.5 parts by weight of silicon-based leveling agent, diluting the mixture with cyclohexanone having a vapor pressure of 3.95 mmHg (5.3 hPa) at 20° C. and a vapor pressure of 5 mmHg (6.7 hPa) at 26.4° C., adjusting the solids concentration to 40 wt %, and stirring with a high-speed stirrer for 3 minutes.

In Example 5, the total light transmittance of the prepared hard coat film (functional film) was 91.4%, and the haze was 0.8%.

### Comparative Example 1

The pressure-sensitive adhesive hard coat film was prepared in the same manner as in Example 1, except that the diluent solvent for the coating solution was changed to ethyl acetate, and the pre-drying conditions after coating were changed to drying at 25° C. for 12 seconds and drying at 40° C. for 1 minute in the preparation of the hard coat film.

In Comparative Example 1, the total light transmittance of the prepared hard coat film (functional film) was 91.4%, and the haze was 1.1%.

### Comparative Example 2

The pressure-sensitive adhesive hard coat film was prepared in the same manner as in Example 1, except that the leveling agent was not added at all, and the solids concentration of the coating solution was changed to 30 wt % by dilution with ethyl cellosolve in the preparation of the hard coat film.

In Comparative Example 2, the total light transmittance of the prepared hard coat film (functional film) was 90.5%, and the haze was 1.4%.

(Evaluation)

The following measurements and evaluations were performed with respect to the pressure-sensitive adhesive hard coat film obtained in the Examples and the Comparative Examples. The approximate integral value calculated by using the above transmittance curves at a wavelength of 400 to 780 nm of the pressure-sensitive adhesive hard coat film was calculated in the above order, and the results were shown in Table 2.

(1) Amount of the Extracted (Meth)Acrylic Acid Ion

The pressure-sensitive adhesive hard coat film obtained in the Examples and the Comparative Examples were cut into pieces each having the size of width 10 cm×length 10 cm. Thereafter, the release liner was peeled and the pressure-sensitive adhesive surface was exposed to prepare for a sample for evaluation (exposed area of the pressure-sensitive adhesive surface: 100 cm²).

Subsequently, the sample for evaluation was put in pure water (50 ml) at a temperature of 100° C., and the pure water was boiled for 45 min to perform a boiling extraction, thereby obtaining an extraction solution.

Subsequently, the total amount (unit: ng) of the acrylic acid ion and methacrylic acid ion in the obtained extraction solution was measured by using the ion chromatograph method (ion chromatography), and the total amount (amount of extracted (meth)acrylic acid ion, unit: ng/cm²) of the acrylic acid ion and methacrylic acid ion per unit area of the pressure-sensitive adhesive surface (exposed pressure-sensitive adhesive surface) of the sample for evaluation was calculated. In the case where the amount of the extracted (meth)acrylic acid ion was less than the detection limit (detection limit: 2.5 ng), the case was represented by “ND” in Table 2.

(Measuring Condition of Ion Chromatograph Method)

Analysis device: DX-320, manufactured by DIONEX Co., Ltd.

Separation column: Ion Pac AS15 (4 mm×250 mm)

Guard column: Ion Pac AG15 (4 mm×50 mm)

Removal system: ASRS-ULTRA (External mode, 100 mA)

Detector: electric conductivity detector

Eluent:
7 mM KOH (0 to 20 min)
45 mM KOH (20 to 30 min)
(eluent generator EG40 was used)

Flow rate of eluent: 1.0 ml/min

Injection amount of sample: 250 μl

(2) Total Light Transmittance

In order to measure the total light transmittance in the visible wavelength region, the release liner was peeled from the pressure-sensitive adhesive hard coat film obtained in the Examples and the Comparative Examples, followed by laminating to a slide glass (having a total light transmittance of 91.8% and a haze of 0.4%) not to let bubbles penetrate inside, and a haze meter (trade name “HM-150”, manufactured by Murakami Color Research Laboratory Co., Ltd.) was used in accordance with JIS K7361-1.

(3) Haze

In order to measure the haze, the release liner was peeled from the pressure-sensitive adhesive hard coat film obtained in the Examples and the Comparative Examples, followed by laminating to a slide glass (having a total light transmittance of 91.8% and a haze of 0.4%) not to let bubbles penetrate inside, and a haze meter (trade name “HM-150”, manufactured by Murakami Color Research Laboratory Co., Ltd.) was used in accordance with JIS K7136 (Haze (Fogging)).

(4) Evaluation of Interference Fringes

A sample for evaluation was prepared by peeling the release liner from the pressure-sensitive adhesive hard coat film obtained in the Examples and the Comparative Examples, and laminating the black acrylic plate (manufactured by Mitsubishi Rayon Co., Ltd., thickness: 2.0 mm) to the surface of the pressure-sensitive adhesive layer. The hard coat layer side of the sample for evaluation was observed with eyes by using three-wavelength fluorescent lamp, and the interference fringes were evaluated according to the following criteria.

1: Interference fringes were confirmed in an interval of a few mm.

2: Interference fringes were confirmed in an interval of a few cm.

3: There are some interference fringes (the intermediate level between 2 and 4).

4: The change of interference color was slightly confirmed.

5: Interference fringes were hardly noticeable.

(5) Corrosion Resistance

Each of the pressure-sensitive adhesive hard coat films obtained in the Examples and the Comparative Examples was cut into pieces having the size of width 20 mm x length 50 mm, thereby preparing a sample.

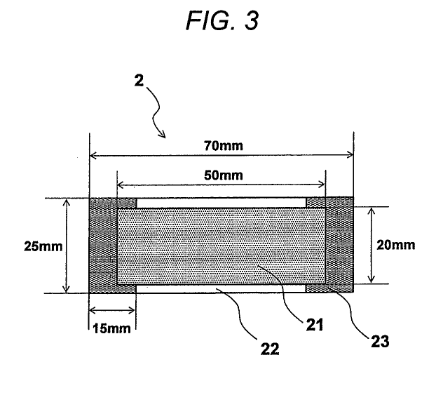

As shown in FIG. 3, the silver paste were coated on both sides of the conductive PET film (trade name “ELECRYSTA P-400L TNMP”, manufactured by Nitto Denko Corp.) (size: length 70 mm×width 25 mm) in the width of 15 mm, followed by laminating the pressure-sensitive adhesive surface of the film piece 21, from which the release liner was peeled, to the conductive surface thereof (ITO film-formed surface 22 side) to prepare the sample for evaluation. After this sample for evaluation was left standing for 24 hours under the environment of 23° C., it was left standing for 250 hours under each of the environment of 60° C. and 95% RH and the environment of 80° C., and then, the ratio (%) of the “resistance value after the laminate was left standing at 60° C. and 95% RH for 250 hours” to the “resistance value immediately after the lamination” [=(resistance value after the laminate was left standing at 60° C. and 95% RH for 250 hours)/(resistance value immediately after the attachment)×100(%)], and the ratio (%) of the “resistance value after the laminate was left standing at 80° C. for 250 hours” to the “resistance value immediately after the attachment” [=(resistance value after the laminate was left standing at 80° C. for 250 hours)/(resistance value immediately after the attachment)×100(%)] were measured, respectively. The resistance value was measured by attaching electrodes to the silver paste parts 23 of both ends of the sample for evaluation by using “3540 Miliohm Hightester” manufactured by Hioki Electric Co., Ltd.

If both of the ratio of the “resistance value after the laminate was left standing at 60° C. and 95% RH for 250 hours” to the “resistance value immediately after the attachment”, and the ratio (%) of the “resistance value after the laminate was left standing at 80° C. for 250 hours” to the “resistance value immediately after the attachment” were less than 120%, the corrosion resistance was evaluated as “good”, and if any one of the ratios was 120% or more, the corrosion resistance was evaluated as “faulty”.

Further, as a blank, the same test was performed without laminating the pressure-sensitive adhesive hard coat film to the conductive PET film both sides of which were coated with silver paste. As a result, the ratio of the “resistance value after being left for 250 hours” to the “resistance value before being left for 250 hours” was 110% at 80° C., and 120% at 60° C. and 95% RH, respectively.

TABLE 2

| | Total light | | | Interference | | Amount of extracted | |
|---|---|---|---|---|---|---|---|
| | transmittance | Haze | Approximate | fringes | Pencil | (meth)acrylic acid ion | Corrosion |
| | [%] | [%] | integral value | Evaluation | hardness | [ng/cm²] | resistance |
| Example 1 | 91.3 | 0.6 | 22.0 | 3 | 3H | ND | Good |
| Example 2 | 91.4 | 0.5 | 1.6 | 5 | 3H | ND | Good |
| Example 3 | 91.5 | 0.6 | 4.8 | 4 | 3H | ND | Good |
| Example 4 | 91.2 | 0.6 | 15.0 | 3 | 3H | ND | Good |
| Example 5 | 91.6 | 0.8 | 28.8 | 3 | 3H | ND | Good |
| Comparative | 91.4 | 1.0 | 51.6 | 2 | 3H | ND | Good |
| Example 1 | | | | | | | |
| Comparative | 90.5 | 1.2 | 149.8 | 1 | 3H | ND | Good |
| Example 2 | | | | | | | |

As is clear from the results of Table 2, in the pressure-sensitive adhesive hard coat film of the present invention (Examples), the interference fringes hardly occur, and further, the corrosion resistance is excellent. In contrast, when the approximate integral value which was calculated using the transmittance curves at the measurement wavelength of 400 to 780 nm is too large (Comparative Example), the interference fringes tend to occur easily.

While the invention has been described in detail and with reference to specific embodiments thereof, it will be apparent to one skilled in the art that various changes and modifications can be made therein without departing from the spirit and scope thereof.

This application is based on Japanese Patent Application No. 2011-096497 filed on Apr. 22, 2011, the entire subject matter of which is incorporated herein by reference.

The present invention provides the following pressure-sensitive adhesive function film and display device.

(1) A pressure-sensitive adhesive functional film, comprising:

a transparent substrate;

at least one functional layer selected from the group consisting of a hard coat layer and an anti-reflection layer on one surface of the transparent substrate; and

a pressure-sensitive adhesive layer on the other surface of the transparent substrate,

wherein a total amount of an acrylic acid ion and a methacrylic acid ion, which are extracted from the pressure-sensitive adhesive functional film with pure water under the condition of 100° C. and 45 min, is 20 ng/cm² or less per unit area of the pressure-sensitive adhesive layer, as measured by an ion chromatograph method, and

an approximate integral value calculated by using a transmittance curve at a wavelength of 400 to 780 nm is 50 or less, as measured by a spectral transmittance meter.

(2) The pressure-sensitive adhesive functional film according to (1), wherein the pressure-sensitive adhesive layer comprises an acrylic polymer formed from a component comprising, as essential monomer components, alkyl ester(meth)acrylate and/or alkoxy alkyl ester(meth)acrylate, and a polar group-containing monomer.

(3) The pressure-sensitive adhesive functional film according to (2), wherein the polar group-containing monomer comprises a hydroxyl group-containing monomer.

(4) The pressure-sensitive adhesive functional film according to any one of (1) to (3), comprising:

a functional film comprising the transparent substrate, and the hard coat layer on one surface of the transparent substrate; and

the pressure-sensitive adhesive layer on the other surface of the transparent substrate which is on the side opposite to the hard coat layer,

wherein the functional film has a total light transmittance of 87% or more and a haze of 1.5% or less, and a pencil hardness on the surface of the hard coat layer is HB or harder.

(5) A display device comprising the pressure-sensitive adhesive functional film according to any one of (1) to (4).

### DESCRIPTION OF REFERENCE NUMERALS AND SIGNS

1: Pressure-sensitive adhesive functional film
11: Functional layer
12: Transparent substrate
13: Pressure-sensitive adhesive layer
14: Release liner
15: Functional film
2: Sample for evaluation
21: Film piece (pressure-sensitive adhesive functional film)
22: ITO film-formed surface
23: Silver paste parts

What is claimed is:

1. A pressure-sensitive adhesive functional film, comprising:
a transparent substrate;
at least one functional layer selected from the group consisting of a hard coat layer and an anti-reflection layer on one surface of the transparent substrate; and
a pressure-sensitive adhesive layer on the other surface of the transparent substrate,
wherein a total amount of an acrylic acid ion and a methacrylic acid ion, which are extracted from the pressure-sensitive adhesive functional film with pure water under the condition of 100° C. and 45 min, is 20 ng/cm² or less per unit area of the pressure-sensitive adhesive layer, as measured by an ion chromatograph method, and
an approximate integral value calculated by using a transmittance curve at a wavelength of 400 to 780 nm is 50 or less, as measured by a spectral transmittance meter.

2. The pressure-sensitive adhesive functional film according to claim 1, wherein the pressure-sensitive adhesive layer comprises an acrylic polymer formed from a component comprising, as essential monomer components, alkyl ester(meth)acrylate and/or alkoxy alkyl ester(meth)acrylate, and a polar group-containing monomer.

3. The pressure-sensitive adhesive functional film according to claim 2, wherein the polar group-containing monomer comprises a hydroxyl group-containing monomer.

4. The pressure-sensitive adhesive functional film according to claim 1, comprising:
a functional film comprising the transparent substrate, and the hard coat layer on one surface of the transparent substrate; and
the pressure-sensitive adhesive layer on the other surface of the transparent substrate which is on the side opposite to the hard coat layer,
wherein the functional film has a total light transmittance of 87% or more and a haze of 1.5% or less, and a pencil hardness on the surface of the hard coat layer is HB or harder.

5. A display device comprising the pressure-sensitive adhesive functional film according to claim 1.

6. The pressure-sensitive adhesive functional film according to claim 2, comprising:
a functional film comprising the transparent substrate, and the hard coat layer on one surface of the transparent substrate; and
the pressure-sensitive adhesive layer on the other surface of the transparent substrate which is on the side opposite to the hard coat layer,
wherein the functional film has a total light transmittance of 87% or more and a haze of 1.5% or less, and a pencil hardness on the surface of the hard coat layer is HB or harder.

7. The pressure-sensitive adhesive functional film according to claim 3, comprising:
a functional film comprising the transparent substrate, and the hard coat layer on one surface of the transparent substrate; and
the pressure-sensitive adhesive layer on the other surface of the transparent substrate which is on the side opposite to the hard coat layer,
wherein the functional film has a total light transmittance of 87% or more and a haze of 1.5% or less, and a pencil hardness on the surface of the hard coat layer is HB or harder.

8. A display device comprising the pressure-sensitive adhesive functional film according to claim 2.

9. A display device comprising the pressure-sensitive adhesive functional film according to claim 3.

10. A display device comprising the pressure-sensitive adhesive functional film according to claim 4.

11. A display device comprising the pressure-sensitive adhesive functional film according to claim 6.

12. A display device comprising the pressure-sensitive adhesive functional film according to claim 7.
